(19) United States
(12) Patent Application Publication
(10) Pub. No.: US 2012/0235569 A1
(43) Pub. Date: Sep. 20, 2012

(54) NOZZLE FOR GENERATING MICROWAVE PLASMA FROM COMBUSTION FLAME

(75) Inventors: Sang Hun Lee, San Ramon, CA (US); Joong Soo Kim, Los Altos, CA (US); Jae-mo Koo, Palo Alto, CA (US); Orion Weihe, Fremont, CA (US); Andrew Way, San Jose, CA (US); Richard Warfield, Fremont, CA (US)

(73) Assignee: AMARANTE TECHNOLOGIES, INC/, Santa Clara, CA (US)

(21) Appl. No.: 13/050,966

(22) Filed: Mar. 18, 2011

(51) Int. Cl. H05H 1/46; B23K 10/00

(52) U.S. Cl. 315/111.41; 219/121.48

(57) ABSTRACT

Systems for generating microwave plasma from a combustion flame. The present invention provides a microwave plasma nozzle that includes a hollow cylindrical housing through which combustible material flows, and a rod-shaped conductor disposed in the housing. A portion of the rod-shaped conductor extends into a microwave cavity to receive microwaves passing in the cavity. The rod-shaped conductor transmits microwaves along the surface thereof, and has a distal end disposed in proximity to and surrounded by a proximal end portion of the housing. During operation, a combustion flame is formed in proximity to the proximal end portion of the housing, and the microwaves transmitted along the surface heat up the flame to generate plasma in proximity to the distal end of the rod-shaped conductor.

### BACKGROUND OF THE INVENTION

1. Field of the Invention

The present invention relates to plasma generators, and more particularly to devices having a combustion nozzle that generates microwave plasma from a combustion flame.

2. Discussion of the Related Art

In a typical combustion engine, the efficiency of the engine is dependent on the efficient combustion of the fuel-air mixture in the combustion chamber. Also, the pollution characteristics of the engine are highly affected by the combustion efficiency.

Several approaches have been proposed to enhance the combustion efficiency. For example, U.S. Pat. No. 7,671,309 discloses a microwave combustion system that generates pulses of microwave energy to ignite a fuel mixture in a cylinder. This system, like the other existing systems, limits the usage microwave energy to ignite the fuel-air mixture. The efficiency of the engine can be enhanced by transferring the microwave energy to the fuel-air mixture (or the flame), thereby electronically exciting the fuel-air mixture (or the flame) in the engine. As such, the existing systems fail to provide any method to enhance the combustion efficiency by transferring the microwave energy. Accordingly, there is a need for systems that can transfer the microwave energy to fuel-air mixture (or flame) to enhance the combustion efficiency.

### SUMMARY OF THE INVENTION

According to one aspect of the present invention, a nozzle for generating both a combustion flame and plasma from microwaves and the combustion flame is disclosed. The nozzle includes a hollow cylindrical housing through which combustible material flows, and a rod-shaped conductor disposed in the housing. The rod-shaped conductor transmits microwaves along the surface thereof and has a distal end disposed in proximity to and surrounded by a proximal end portion of the housing. During operation, a combustion flame is formed in proximity to the proximal end portion of the housing, and the microwaves transmitted along the surface heat up the flame to generate plasma in proximity to the distal end of the rod-shaped conductor.

According to another aspect of the present invention, a nozzle for generating both a combustion flame and plasma from microwaves and the combustion flame is disclosed. The nozzle includes a hollow cylindrical housing through which gas flows, and a rod-shaped conductor disposed in the housing. The rod-shaped conductor transmits microwaves along a surface thereof and has a distal end disposed in proximity to and surrounded by a proximal end portion of the housing. The rod-shaped conductor is a tube so that combustible material can flow through the tube. During operation, a combustion flame is formed in proximity to the distal end of the rod-shaped conductor and the microwaves transmitted along the surface heat up the flame to generate plasma in proximity to the distal end of the rod-shaped conductor.

According to yet another aspect of the present invention, a plasma generating system is disclosed. The system includes: a microwave generator for generating microwaves, a power supply connected to the microwave generator for providing power thereto, a microwave cavity, a waveguide operatively connected to the microwave cavity for transmitting the microwaves thereto, an isolator for dissipating microwaves reflected from the microwave cavity, and a nozzle secured to the microwave cavity. The nozzle includes a hollow cylindrical housing through which combustible material flows, and a rod-shaped conductor disposed in the housing. The rod-shaped conductor transmits microwaves along the surface thereof and has a distal end disposed in proximity to and surrounded by a proximal end portion of the housing. During operation, a combustion flame is formed in proximity to the proximal end portion of the housing and the microwaves transmitted along the surface heat up the flame.

According to still another aspect of the present invention, a plasma generating system is disclosed. The system includes: a microwave generator for generating microwaves, a power supply connected to the microwave generator for providing power thereto, a microwave cavity, a waveguide operatively connected to the microwave cavity for transmitting the microwaves thereto, an isolator for dissipating microwaves reflected from the microwave cavity, and a nozzle secured to the microwave cavity. The nozzle includes a hollow cylindrical housing through which gas flows, and a rod-shaped conductor disposed in the housing. The rod-shaped conductor transmits microwaves along a surface thereof and has a distal end disposed in proximity to and surrounded by a proximal end portion of the housing. The rod-shaped conductor is a tube so that combustible material can flow through the tube. During operation, a combustion flame is formed in proximity to the distal end of the rod-shaped conductor and the microwaves transmitted along the surface heat up the flame to generate plasma in proximity to the distal end of the rod-shaped conductor.

These and other advantages and features of the invention will become apparent to those persons skilled in the art upon reading the details of the invention as more fully described below.

### BRIEF DESCRIPTION OF THE DRAWINGS

FIG. 1 is a schematic diagram of a plasma generating system in accordance with one embodiment of the present invention.

FIG. 2 is a partial cross-sectional view of the microwave cavity and nozzle taken along line 2-2 shown in FIG. 1.

FIGS. 3A and 3B are partial cross-sectional views of alternative embodiments of the nozzle shown in FIG. 2.

FIGS. 4A-4E are cross-sectional views of alternative embodiments of the rod-shaped conductor shown in FIG. 2.

FIG. 5A shows a perspective view of a nozzle secured to a microwave cavity in accordance with another embodiment of the present invention.

FIG. 5B shows a side cross-sectional view of the nozzle in FIG. 5A, taken along the line 5B-5B.

FIG. 6 shows a flow chart illustrating the exemplary steps for generating microwave plasma using the system shown in FIG. 1 in accordance with an embodiment of the present invention.

### DETAILED DESCRIPTION OF THE PREFERRED EMBODIMENTS

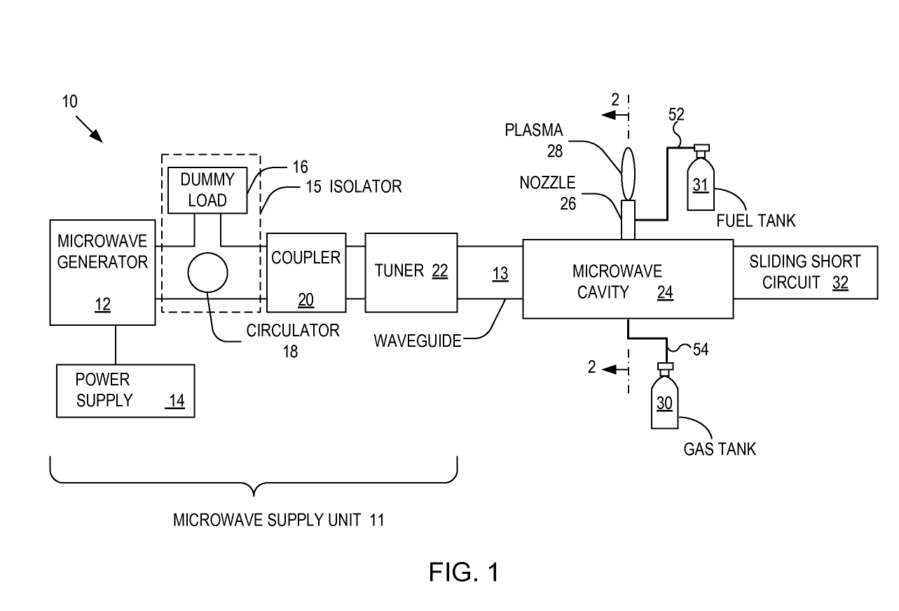

FIG. 1 is a schematic diagram of a system 10 for generating microwave plasma in accordance with one embodiment of the present invention. As illustrated, the system 10 may include: a microwave cavity 24, a microwave supply unit 11 for providing microwaves to the microwave cavity 24, a waveguide 13 for transmitting microwaves from the microwave supply unit 11 to the microwave cavity 24, a nozzle 26 connected to the microwave cavity 24, and a gas tank 30 for providing cooling gas to the nozzle 26. The nozzle 26 functions as a burner that generates a combustion flame by burning the fuel received from a fuel tank 31, and as a plasma plume generator that generates a plasma plume 28 by using microwave energy received from the microwave cavity 24. A commercially available sliding short circuit 32 can be attached to the microwave cavity 24 to control the microwave energy distribution within the microwave cavity 24 by adjusting the microwave phase. It is noted that the system 10 includes one nozzle. However, it should be apparent to those of ordinary skill in the art that the systems may include other suitable number of nozzles.

The fuel may be a mixture of combustible material and air and prepared in a suitable storage, such as the fuel tank 31, before injection into the nozzle. Alternatively, the fuel may be pure combustible material and atmospheric air may be mixed with the fuel at the nozzle exit. For the purpose of illustration, the fuel is considered a flammable gas in the following sections, even though the fuel may be in liquid or solid state.

The microwave supply unit 11 provides microwaves to the microwave cavity 24 and may include: a microwave generator 12 for generating microwaves, a power supply for supplying power to the microwave generator 14, and an isolator 15 having a dummy load 16 for dissipating reflected microwaves that propagates toward the microwave generator 12, and a circulator 18 for directing the reflected microwaves to the dummy load 16. It is noted that the microwave cavity 24 can be a portion of the waveguide 13, i.e., the dimension and material of the microwave cavity 24 are similar to those of the waveguide 13. As such, the terms microwave cavity and waveguide are used interchangeably.

In one embodiment, the microwave supply unit 11 further includes a coupler 20 for measuring fluxes of the microwaves, and a tuner 22 for reducing the microwaves reflected from the microwave cavity 24. The components of the microwave supply unit 11 shown in FIG. 1 are well known and are listed herein for exemplary purposes only. Also, it is possible to replace the microwave supply unit 11 with a system having the capability to provide microwaves to the microwave cavity 24 without deviating from the present invention. Likewise, the sliding short circuit 32 may be replaced by a phase shifter that can be configured in the microwave supply unit 11. Typically, a phase shifter can be mounted between the isolator 15 and the coupler 20.

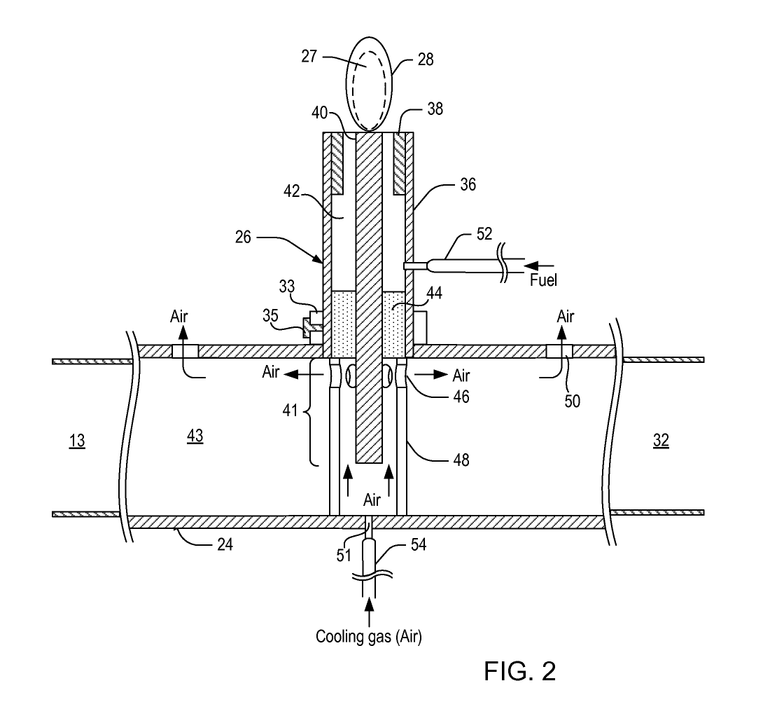

FIG. 2 is a partial cross-sectional view of the microwave cavity 24 and the nozzle 26 taken along line 2-2 in FIG. 1. As shown in FIG. 2, the microwave cavity 24 includes a wall, which forms cavity 43 for containing the microwaves transmitted from the microwave generator 12, and includes an inlet hole 51 for admitting the cooling gas (such as air) from the gas tank 30 (or any other suitable gas supply) via a gas line 54 and one or more outlet holes 50 for discharging heated gas therethrough. (Hereinafter, air is an exemplary cooling gas for the purpose of illustration.)

The nozzle 26 includes: a housing/shield 36 attached to the cavity wall and a gas channel 42 for having a flow of fuel therethrough, a rod-shaped conductor 40 having a portion 41 disposed in the microwave cavity 24 for receiving microwaves from within the microwave cavity 24, a ring-shaped dielectric tube 38, preferably formed of quarts, for preventing electric arc between the rod-shaped conductor 40 and the inner surface of the housing 36, a ring-shaped rod-holder 44 for securely holding the rod-shaped conductor 40 in place relative to the housing 36, and a cooling gas tube 48 extending through the cavity 24 and forming a channel for the cooling gas. The housing 36 provides a mechanical support of the nozzle 26 and has a hole through which the fuel received from the fuel tank 31 via the gas line 52 is injected. At least some parts of an outlet portion of the housing 36 can be made of electrically conducting material, such as metal. The conducting materials used as part of the housing 36 will act as a shield and improve plasma efficiencies. The rod-holder 44 is formed of dielectric material, such as plastic, nylon, or Teflon. The cooling gas tube 48 may be formed of any suitable material that is transparent to microwaves and includes one or more holes 46 through which the heated air is discharged.

The fuel, which can be a mixture of methane and air, for instance, flows through the channel 42 and exits the nozzle 26 at the distal end of the nozzle. A suitable ignition mechanism (not shown in FIG. 2) can be used to ignite the fuel, thereby forming a combustion flame 27 at the nozzle exit.

The heat energy generated by the flame 27 is transferred to the rod-shaped conductor 40 and the rod-holder 44 that is tightly fitted around the rod-shaped conductor 40. The rod-holder 44, which is formed of a dielectric material, could be damaged by the heat energy unless the heat energy is properly dissipated. The inlet hole 51 is aligned with the proximal end (or, equivalently, inlet) of the cooling gas tube 48 so that the cooling gas flows through the tube 48. The cooling gas flowing through the cooling gas tube 48 extracts the heat energy from the rod-shaped conductor 40 and the rod-holder 44. The heated cooling gas exits through the holes 46 formed in the cooling gas tube 48 and subsequently through the outlet holes 50 formed in the cavity wall.

The collection portion 41 of the rod-shaped conductor 40 acts as an antenna to collect microwaves from the microwave cavity 24, and focuses the collected microwaves to a distal tip to generate plasma 28 from the flame 27. More specifically, the microwave energy discharged at the distal end of the nozzle heats up the flame 27 into plasma so that the gas species in the flame is electronically and/or thermally excited. Such excitation, which results in substantial increase in the intensity of light emanating from the plume 28, is believed to enhance the combustion efficiency.

The rod-shaped conductor 40 may be made of any material that can conduct microwaves. The rod-shaped conductor 40 can be made out of copper, aluminum, platinum, gold, silver, and other conducting materials. The term rod-shaped conductor is intended to cover conductors having various cross sections such as a circular, oval, elliptical, or an oblong cross section or combinations thereof.

The nozzle 26 is detachably secured to a ring-shaped flange 33 by one or more fasteners 35, where the flange 33 is permanently secured to the cavity 24. It should be apparent to those of ordinary skill in the art that the nozzle 26 can be secured to the microwave cavity 24 by other suitable mechanisms, such as welding, and that the flange 33 can be detachably secured to the microwave cavity 24 by fasteners without deviating from the scope of the present teachings.

The ring-shaped dielectric tube 38 may be secured to the inner wall of the housing 36 by a suitable mechanism, such as glue or screw (not shown in FIG. 2). The ring-shaped dielectric tube 38 may extend through the entire length of the gas channel 42 when there is a high probability of arcing between the rod shaped conductor 40 and the housing 36. It is also noted that the ring-shaped dielectric tube 38 may not be used if the probability of arcing is low.

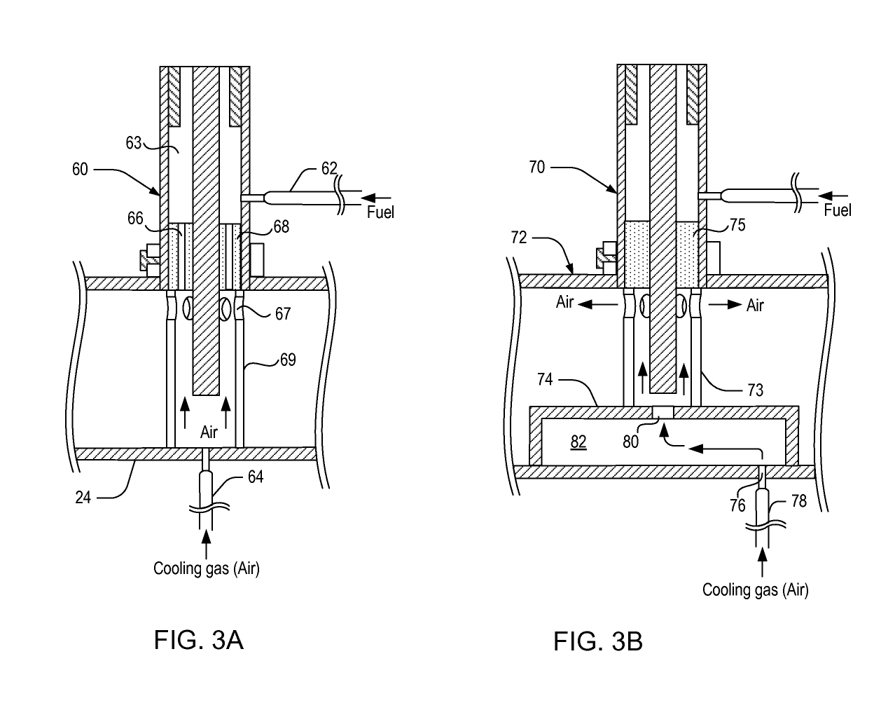

FIG. 3A is a partial cross-sectional view of a nozzle 60 in accordance with another embodiment of the present invention. As depicted, the nozzle 60 is similar to the nozzle 26 in FIG. 2, with the difference that the rod-holder 68 has one or more through-pass holes or passages 66. A portion of the cooling air injected into the cooling gas tube 69 via a line 64 passes through the passage 66, and is mixed with the fuel injected via a line 62 to form a combustible mixture in a channel 63. As an alternative, the through-pass holes or passages 66 are angled relative to the longitudinal axis of the rod-shaped conductor, so that a helical or spiral flow of heated cooling air would be imparted to the gas flowing through the gas channel 63. However, the passage or passages may have other geometric flow path shapes as long as the flow path causes a swirling flow around the rod-shaped conductor.

FIG. 3B is a partial cross-sectional view of a nozzle 70 in accordance with another embodiment of the present invention. As depicted, the nozzle 70 is similar to the nozzle 26 in FIG. 2, with the difference that the wall of a cavity 72 includes an additional gas channel 74 forming a passage 82 for the cooling gas injected through a hole 76 in the cavity wall via a gas line 78. The gas channel 74 includes one or more holes 80 formed in the wall thereof and aligned with the cooling gas tube 73 of the nozzle 70. As an alternative, the rod-holder 75 may have a through-pass hole as the rod-holder 68 (shown in FIG. 3A) so that a portion of the heated cooling gas may be mixed with fuel.

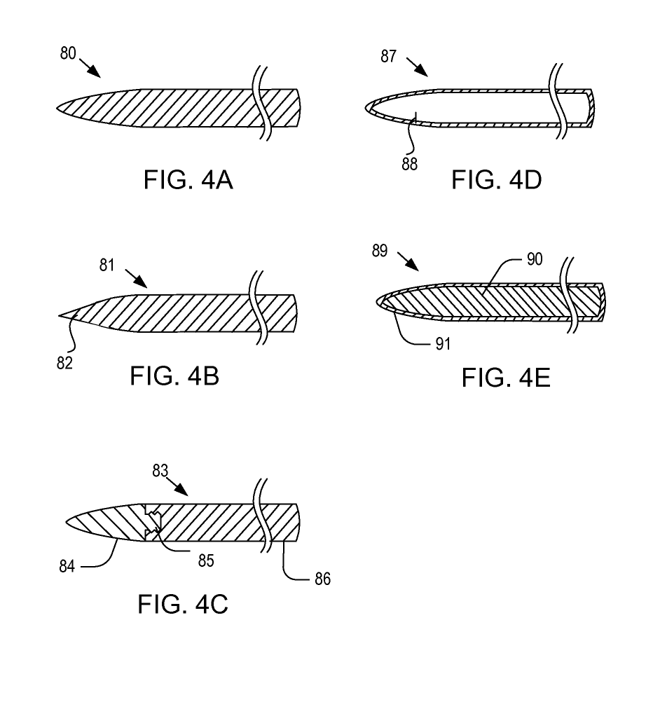

As illustrated in FIG. 2, the microwaves are received by the collection portion 41 of the rod-shaped conductor 40 extending into the microwave cavity 24. These microwaves travel down the rod-shaped conductor toward the distal tip at the nozzle exit. It is known that microwave energy can be focused on a sharp corner or edge. Thus, to focus the microwaves at the tip and thereby to facilitate the plasma ignition, the rod-shaped conductor 80 may have a sharp distal tip at the nozzle exit, as shown in FIG. 4A.

FIG. 4B is a cross-sectional view of yet another embodiment of the rod-shaped conductor, wherein a rod-shaped conductor 81 includes a conically-tapered tip 82. Other cross-sectional variations can also be used. For example, conically-tapered tip 82 may be eroded by plasma faster than another portion of rod-conductor 81 and thus may need to be replaced on a regular basis. FIG. 4C is a cross-sectional view of another embodiment of the rod-shaped conductor, wherein a rod-shaped conductor 83 has a tapered section 84 secured to a cylindrical portion 86 by a suitable fastening mechanism 85 (in this case, the tapered section 84 can be screwed into the cylindrical portion 86 using the screw end 85) for easy and quick replacement thereof.

It is well known that the microwaves captured by an electrically conducting body travel along the surface of the body, and that the depth of the skin responsible for microwave penetration and migration is a function of the microwave frequency and the conductor material. Typically, the microwave penetration distance can be less than a millimeter from the surface of the body. Thus, a rod-shaped conductor 87 of FIG. 4D having a hollow portion 88 can an alternative embodiment for the rod-shaped conductor, as long as the thickness of the rod-shaped conductor 87 is greater than the skin depth.

It is well known that some precious metals are good microwave conductors. Thus, to reduce the unit price of the device without compromising the performance of the rod-shaped conductor, the skin layer of the rod-shaped conductor can be made of precious metals that are good microwave conductors, while cheaper conducting materials can be used for inside of the core. FIG. 4E is a cross-sectional view of another embodiment of a rod-shaped conductor, wherein a rod-shaped conductor 89 includes skin layer 91 made of a precious metal and a core 90 made of a cheaper conducting material.

It is noted that each of the rod-shaped conductors in FIGS. 4B-4E is shown to have a sectional dimension that varies along the longitudinal axis of the rod-shaped conductor. However, it should be apparent to those of ordinary skill in the art that each of the embodiments may have a uniform cross sectional shape along the longitudinal axis. For instance, the core 90 of the rod-shaped conductor 89 (shown in FIG. 4E) may have a circular cylindrical shape with a uniform cross section throughout the entire length of the rod. It is noted that the embodiments shown in FIGS. 4A-4E can be applied to the nozzles 26, 60, and 70.

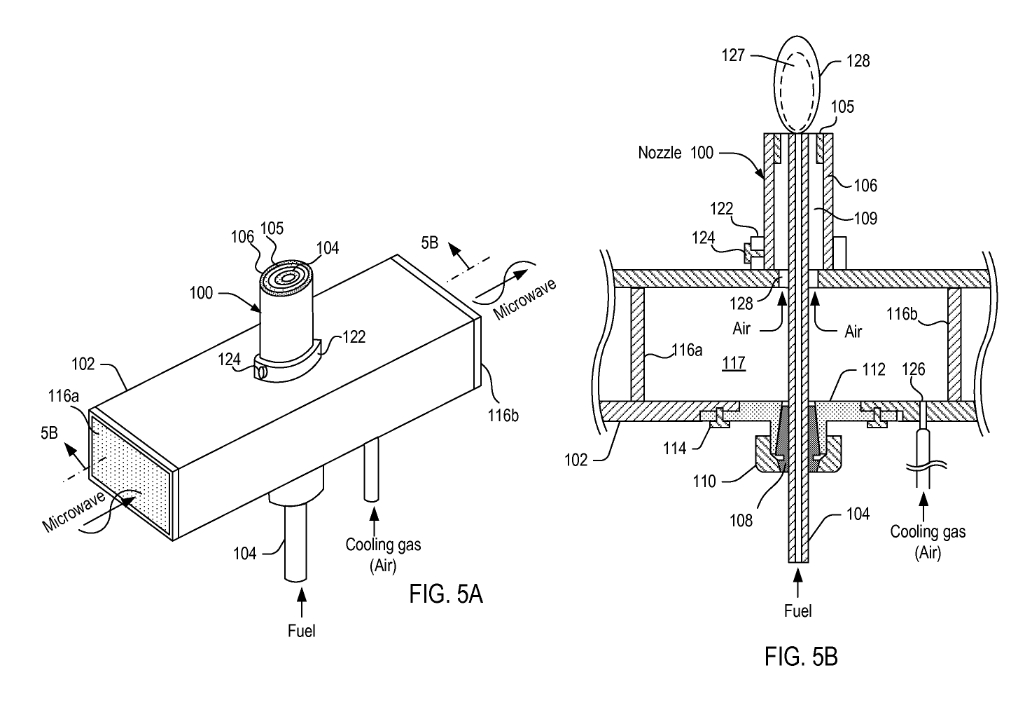

FIG. 5A shows a perspective view of a nozzle 100 secured to a waveguide (or microwave cavity) 102 in accordance with another embodiment of the present invention. FIG. 5B shows a side cross-sectional view of the nozzle 100, taken along the line 5B-5B. As depicted, the nozzle 100 is secured to a ring-shaped flange 122 of the waveguide 102 by one or more fasteners 124 and includes: a rod-shaped conductor 104, a housing/shield 106, and a dielectric tube 105 secured to the housing 106 by a suitable fastening mechanism, such as glue or screw (not shown in FIG. 5B). The materials and functions of the housing 106 and dielectric tube 105 are similar to those of the housing 36 and dielectric tube 38 (shown in FIG. 2), respectively.

The rod-shaped conductor 104 is a tube having a through-pass hole that extends throughout the entire length of the conductor 104. The fuel is injected through the proximal end (or, the bottom tip) of the rod-shaped conductor 104. At the distal end (or the upper tip) of the rod-shaped conductor 104, a combustion flame is formed by use of a suitable ignition mechanism (not shown in FIG. 5B) for igniting the fuel. The fuel may be a mixture of combustible material and air and prepared in a suitable storage, such as tank, before injection into the nozzle. Alternatively, the fuel may be pure combustible material and atmospheric air (and the heated cooling gas) may be mixed with the fuel at the nozzle exit.

The rod-shaped conductor 104 is held in position relative to the housing 106 by a holding mechanism, where the holding mechanism includes a collet 108 (such as ER16 collet manufactured by DeAlmond Tool at Amarillo, Tex.), a collet holder 112 secured to the waveguide 102 by fasteners 114 and configured to accept the collet 108, and a knob 110 for tightening (or loosening) the collet 108.

The waveguide 102 includes at least one inlet hole 126 for receiving a cooling gas therethrough and one or more outlet holes 128 aligned with a channel 109 of the nozzle 100. The combustion flame 127 formed at the upper tip of the rod-shaped conductor 104 generates heat energy during operation and the heat energy is transferred to the rod-shaped conductor 104 by conduction. The cooling gas extracts the heat energy from the rod-shaped conductor 104 as it flows along the surface of the rod-shaped conductor 104 and is discharged at the nozzle exit.

Two walls, 116a and 116b, are disposed in the waveguide 102, forming an enclosed space 117 surrounded by the two walls and the waveguide walls. The cooling gas injected into the enclosed space 117 through the inlet hole 126 exits the space through the outlet holes 128. The walls 116a and 116b may be formed of a material that is transparent to the microwave so that the microwave can pass through the walls, and thus the portion of the rod-shaped conductor 104 extending through enclosed space 117 can collect the microwaves. During operation, the collected microwaves travel along the rod-shaped conductor 104 and plasma 128 may be generated at the distal end of the rod-shaped conductor 104 using the microwave energy.

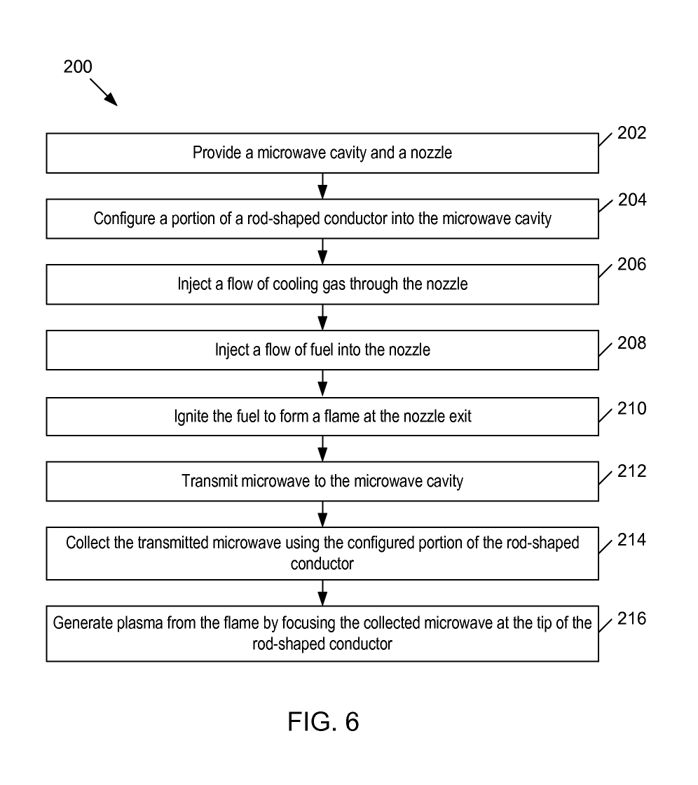

FIG. 6 shows a flowchart 200 showing an example of the steps that may be taken to generate microwave plasma using the system shown in FIG. 1. In a step 202, a microwave cavity and a nozzle are provided. Next, in a step 204, a portion of the rod-shaped conductor is configured into the microwave cavity so that the portion of the rod-shaped conductor can collect microwave energy. Then, in a step 206, cooling gas is injected into the nozzle. Subsequently, fuel is injected into the nozzle and ignited to form a combustion flame at the nozzle exit in steps 208 and 210. Alternatively, the step 206 may be performed after the steps 208 and 210.

In a step 212, microwaves are transmitted to the microwave cavity (or, equivalently waveguide). Next, the transmitted microwaves are received by the configured portion of the rod-shaped conductor in step 214. Subsequently, the collected microwave is focused at the tip of the rod-shaped conductor to heat the gas particles of the combustion flame into plasma in step 216.

While the present invention has been described with reference to the specific embodiments thereof, it should be understood that the foregoing relates to preferred embodiments of the invention and that modifications may be made without departing from the spirit and scope of the invention as set forth in the following claims.

We claim:

1. A nozzle for generating a combustion flame and plasma from microwaves and the combustion flame, comprising:
a hollow cylindrical housing for having a flow of combustible material therethrough; and
a rod-shaped conductor disposed in the housing and operative to transmit microwaves along a surface thereof, the rod-shaped conductor having a distal end disposed in proximity to and surrounded by a distal end portion of the housing,
wherein a combustion flame is formed in proximity to the distal end portion of the housing and the microwaves transmitted along the surface heat up the flame to generate plasma in proximity to the distal end of the rod-shaped conductor during operation.

2. A nozzle as defined in claim 1, further comprising:
a holder disposed in the housing and adapted to hold the rod-shaped conductor in place relative to the housing.

3. A nozzle as defined in claim 1, further comprising:
a microwave cavity, a portion of the rod-shaped conductor being disposed in the microwave cavity.

4. A nozzle as defined in claim 3, further comprising:
a tube disposed in the microwave cavity and surrounding the portion of the rod-shaped conductor to form a channel for a gas flow around the rod-shaped conductor, the tube being formed of material transparent to the microwaves.

5. A nozzle as defined in claim 4, wherein the tube includes at least one hole formed in a wall thereof.

6. A nozzle as defined in claim 5, wherein the microwave cavity includes at least one outlet hole formed in a wall thereof.

7. A nozzle as defined in claim 1, wherein the housing includes a hole formed therein.

8. A nozzle as defined in claim 1, further comprising:
a ring-shaped dielectric ring attached to an inner surface of the housing.

9. A nozzle as defined in claim 4, further comprising:
a holder disposed in the housing and adapted to hold the rod-shaped conductor in place relative to the housing and having at least one through-pass formed therein to provide a fluid communication between the tube and the housing.

10. A nozzle as defined in claim 11, wherein the through-pass is angled with respect to a longitudinal axis of the rod-shaped conductor for imparting a helical shaped flow direction around the rod-shaped conductor to a portion of a gas passing along the through-pass.

11. A nozzle as defined in claim 4, wherein the microwave cavity includes a wall, the wall of the microwave cavity forming a portion of a gas flow passage operatively connected to an inlet portion of the tube.

12. A nozzle as defined in claim 1, wherein the housing is formed of an electrically conducting material.

13. A nozzle as defined in claim 1, wherein the rod-shaped conductor includes two different materials.

14. A nozzle as defined in claim 1, wherein the distal end of the rod-shaped conductor has a pointed tip.

15. A nozzle for generating a combustion flame and plasma from microwaves and the combustion flame, comprising:
a hollow cylindrical housing for having a gas flow therethrough; and
a rod-shaped conductor disposed in the housing and operative to transmit microwaves along a surface thereof, the rod-shaped conductor having a distal end disposed in proximity to and surrounded by a distal end portion of the housing, the rod-shaped conductor being a tube for having a flow of combustible material therethrough,
wherein a combustion flame is formed in proximity to the distal end of the rod-shaped conductor and the microwaves transmitted along the surface heat up the flame to generate plasma in proximity to the distal end of the rod-shaped conductor during operation.

16. A nozzle as defined in claim 15, further comprising:
a microwave cavity,
wherein the rod-shaped conductor extends through the microwave cavity.

17. A nozzle as defined in claim 16, further comprising:
a holding mechanism for holding the rod-shaped conductor in place relative to the housing, the holding mechanism being attached to a wall of the microwave cavity.

18. A nozzle as defined in claim 16, wherein the microwave cavity includes at least one inlet hole formed in a wall thereof.

19. A nozzle as defined in claim 18, wherein the microwave cavity includes at least one outlet hole formed in a wall thereof, the outlet hole being aligned with the housing to provide a fluid communication between the microwave cavity and the housing.

20. A nozzle as defined in claim 16, further comprising:
two walls formed of a material transparent to the microwaves and disposed in the microwave cavity.

21. A nozzle as defined in claim 15, further comprising:
a ring-shaped dielectric ring disposed in the housing.

22. A nozzle as defined in claim 15, wherein the housing is formed of an electrically conducting material.

23. A nozzle as defined in claim 15, wherein the rod-shaped conductor includes two different materials.

24. A microwave plasma nozzle as defined in claim 15, wherein the distal end of the rod-shaped conductor has a pointed tip.

25. A plasma generating system, comprising:
a microwave generator for generating microwaves;
a power supply connected to the microwave generator for providing power thereto;
a microwave cavity;
a waveguide operatively connected to the microwave cavity for transmitting the microwaves thereto;
an isolator for dissipating microwaves reflected from the microwave cavity; and
a nozzle secured to the microwave cavity and including:
a hollow cylindrical housing for having a flow of combustible material therethrough; and
a rod-shaped conductor disposed in the housing and operative to transmit microwaves along a surface thereof, the rod-shaped conductor having a distal end disposed in proximity to and surrounded by a distal end portion of the housing,
wherein a combustion flame is formed in proximity to the distal end portion of the housing and the microwaves transmitted along the surface heat up the flame to generate plasma in proximity to the distal end of the rod-shaped conductor during operation.

26. A plasma generating system as defined in claim 25, wherein the isolator includes:
a dummy load for dissipating the reflected microwaves; and
a circulator attached to the dummy load for directing the reflected microwaves to the dummy load.

27. A plasma generating system, comprising:
a microwave generator for generating microwaves;
a power supply connected to the microwave generator for providing power thereto;
a microwave cavity;
a waveguide operatively connected to the microwave cavity for transmitting the microwaves thereto;
an isolator for dissipating microwaves reflected from the microwave cavity; and
a nozzle secured to the microwave cavity and including:
a hollow cylindrical housing for having a gas flow therethrough; and
a rod-shaped conductor disposed in the housing and operative to transmit microwaves along a surface thereof, the rod-shaped conductor having a distal end disposed in proximity to and surrounded by a distal end portion of the housing, the rod-shaped conductor being a tube for having a flow of combustible material therethrough,
wherein a combustion flame is formed in proximity to the distal end of the rod-shaped conductor and the microwaves transmitted along the surface heat up the flame to generate plasma in proximity to the distal end of the rod-shaped conductor during operation.

28. A plasma generating system as defined in claim 27, wherein the isolator includes:
a dummy load for dissipating the reflected microwaves; and
a circulator attached to the dummy load for directing the reflected microwaves to the dummy load.
